(19) United States
(12) Patent Application Publication
(10) Pub. No.: US 2025/0212739 A1
(43) Pub. Date: Jul. 3, 2025

(54) ALUMINIUM HYDROXIDE HYDROGEL FOR AGRICULTURE

(71) Applicants: QATAR FOUNDATION FOR EDUCATION, SCIENCE AND COMMUNITY DEVELOPMENT, Doha (QA); Qatar University, Doha (QA)

(72) Inventors: Ali Altaee, Doha (QA); Alaa Hawari, Doha (QA); Nasser Al Khalaf, Doha (QA)

(21) Appl. No.: 18/873,116

(22) PCT Filed: Jun. 9, 2023
(86) PCT No.: PCT/QA2023/050010

§ 371 Date: Dec. 9, 2024

Related U.S. Application Data
(60) Provisional application No. 63/351,216, filed on Jun. 10, 2022.

(51) Int. Cl. A01G 24/12; A01G 24/40; C01F 7/021

(52) U.S. Cl. CPC A01G 24/12; A01G 24/40; C01F 7/021

(57) ABSTRACT

An aluminium hydroxide hydrogel for agriculture is provided. The aluminium hydroxide hydrogel includes aluminium polyhydrate and water.

### CROSS-REFERENCE TO RELATED APPLICATION

The present disclosure claims priority to U.S. Provisional Patent Application 63/351,216 having a filing date of Jun. 10, 2022, the entirety of which is incorporated herein.

### BACKGROUND

Water shortage is an alarming problem for agriculture in an arid and semi-arid climate. Unpredictable weather patterns, elevated temperature, and scarce precipitation worsen the environmental conditions for successful agriculture in an arid climate. Gel materials were proposed to supply water for agriculture when water resources are limited, or there are no precipitations for extended periods. The concept of hydrogel agriculture is to provide enough water to plants under extreme weather conditions when gel materials are applied to the soil. A wide range of superabsorbent polymers, for example, acrylamide, acrylonitrile, polyacrylonitrile, acrylic acid and polyacrylamide and many others, are used in hydrogel agriculture as a source of water supply. Despite the advantages of superabsorbents in storing water for agriculture, there are drawbacks to hydrogel agriculture. These drawbacks are represented in the toxicity of hydrogel materials, preparation cost, the biodegradability of superabsorbents, and hence generating a large amount of waste.

### SUMMARY

According to one non-limiting aspect of the present disclosure, an example embodiment of an aluminium hydroxide hydrogel for agriculture is provided.

In another aspect of the present disclosure, which may be combined with any other aspect listed herein unless specified otherwise, an aluminium hydroxide hydrogel, comprises aluminium polyhydrate and water.

In another aspect of the present disclosure, which may be combined with any other aspect listed herein unless specified otherwise, a pH value of the aluminium hydroxide hydrogel is 7.1.

In another aspect of the present disclosure, which may be combined with any other aspect listed herein unless specified otherwise, the aluminium hydroxide hydrogel is biodegradable.

In another aspect of the present disclosure, which may be combined with any other aspect listed herein unless specified otherwise, a method for producing aluminium hydroxide hydrogel comprises providing a mixture of aluminium hydroxide and water, polymerizing aluminium hydroxide, removing water from the aluminium hydroxide, and washing the aluminium hydroxide.

In another aspect of the present disclosure, which may be combined with any other aspect listed herein unless specified otherwise, the water is removed from the aluminium hydroxide by a centrifuge.

In another aspect of the present disclosure, which may be combined with any other aspect listed herein unless specified otherwise, the aluminium hydroxide is washed to remove sodium ions and sulfate ions.

In another aspect of the present disclosure, which may be combined with any other aspect listed herein unless specified otherwise, the aluminium hydroxide hydrogel is used for agriculture.

In another aspect of the present disclosure, which may be combined with any other aspect listed herein unless specified otherwise, a pH value of the aluminium hydroxide hydrogel is 7.1.

Additional features and advantages are described by way of example in, and will be apparent from, the following Detailed Description and the Figures. The figures are schematic and are not intended to be drawn to scale. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

Features and advantages of the present disclosure, including an aluminium hydroxide hydrogel for agriculture, described herein may be better understood by reference to the accompanying drawings in which:

FIG. 1 illustrates four subparts showing the effects of the aluminium hydroxide hydrogel where A) shows the hydrogel setting in compost, B) shows the hydrogel with plans after 7 days, C) shows the hydrogel after 14 days, and D) shows the hydrogel after 14 days top view according to an embodiment of the present disclosure.

FIG. 2: A) Density of aluminium hydrogel, B) pH of aluminium hydrogel, and C) hydrogel drying time according to an embodiment of the present disclosure.

FIG. 3 illustrates drying of centrifuged (4000 RPM for 3 minutes) hydrogel, soil and water, soil and hydrogel samples at room temperature according to an embodiment of the present disclosure. The hydrogel sample dries completely after 21 days while soil and water dried completely just after 1 or 2 days.

FIG. 4 illustrates drying of soil and hydrogel samples according to an embodiment of the present disclosure. The wet soil samples with 8 weight % or 35weight % water dried completely after 24 and 48 hours, respectively. However, centrifuged hydrogel dries completely after 21 days.

FIG. 5 illustrates samples of the fully grown tomatoes and cucumbers using the hydrogel material according to an embodiment of the present disclosure.

FIG. 6 illustrates cucumber production (Kg) and water retention (%) with hydrogel agriculture according to an embodiment of the present disclosure.

The reader will appreciate the foregoing details, as well as others, upon considering the following detailed description of certain non-limiting embodiments of the present disclosure.

### DETAILED DESCRIPTION

The present disclosure is generally related to an aluminium hydroxide hydrogel for agriculture.

Hydrogel agriculture has been proposed to minimize water use or unpredictable water resources available for plant irrigation. There is a wide range of hydrogel materials, but there are several concerns about their applications in the field. The most common concerns are i) the cost of hydrogel ii) biodegradability or compatibility with soils iii) toxicity of hydrogel materials, and iv) impact on the environment. Most hydrogel materials suffer from at least one of the limitations mentioned above, making hydrogel agriculture technology less attractive.

The concerns about using hydrogels in agriculture triggered the search for a more benign and environmentally friendly hydrogel material. The present disclosure discloses a new aluminium hydroxide hydrogel for hydrogel agriculture. The proposed hydrogel materials are prepared by a new method that uses low-cost, nontoxic and environmentally friendly when degraded. The hydrogel materials are compatible with most soils and do not include organic or inorganic toxic materials. The hydrogel degrades within several weeks, making a homogenous mixture with the soil.

The new hydrogel material comprises up to 99% water and 1% aluminium hydroxide polyhydrate. The new hydrogel is inexpensive and nontoxic, and hence it does not raise any environmental concerns.

According to an embodiment of the present disclosure, an aluminium hydroxide hydrogel is provided. Aluminium hydroxide is prepared from the chemical reaction (1) of aluminium sulfate with sodium bicarbonate:

Al₂(SO₄)₃+Na₂CO₃+H₂O→Al(OH)₃+Na₂SO₄+CO₂ [1]

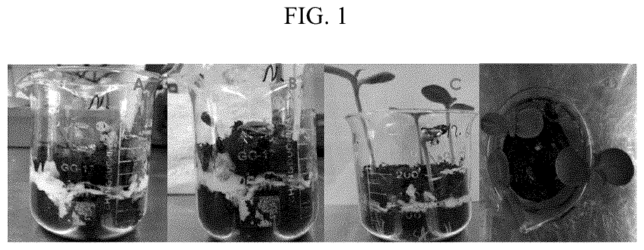

For example, the reaction product, aluminium hydroxide (Al(OH)₃) is left for 2 weeks for polymerization before use. About 99% of aluminium hydroxide hydrogel is water, and it contains trace concentrations of sodium and sulfate ions, which should be removed before use. Fresh aluminium hydroxide hydrogel solution was collected in a 50 mL test tube and centrifuged for 3 minutes at 4000 rpm to concentrate and remove additional water. Then, the hydrogel was washed several times, 3 to 4 times, with DI water to remove sodium and sulfate ions. It should be mentioned that low salinity treated wastewater (TSE) can be used for aluminium hydrogel washing. A compost soil, 5 to 6 cm, was packed at the bottom of a 250 mL beaker and covered with 4 to 8 mm of aluminium hydroxide hydrogel, then covered with 1 to 1.5 cm compost soil (FIG. 1A). Sunflower seeds were put on the top of the hydrogel layer and left in the laboratory at 25° C.±3° C. The compost-hydrogel soil was left without water for 14 days to test the ability of seeds to germinate using the water in the aluminium hydrogel layer. The first seed germination was observed after 7 days of adding water to the compost-hydrogel soil (FIG. 1B). The durability of plants to grow in harsh and arid environments without water supply was extended for 14 days. Results showed the ability of sunflower plants to survive and grow, relying only on hydrogel water (FIGS. 1C and 1D). Furthermore, the aluminium hydrogel will absorb irrigation water and reduce evaporation losses. The compost-hydrogel mixture will be suitable for planting greenhouse vegetables, with the potential of recycling for reuse at the end of the season.

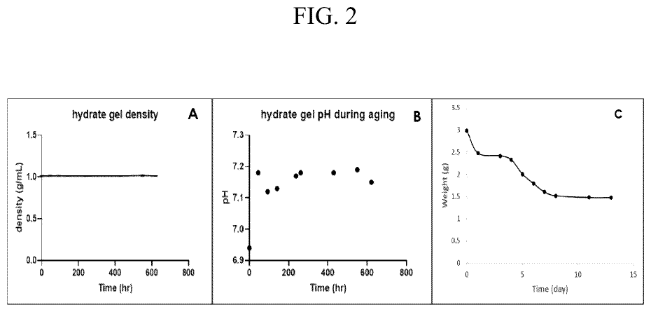

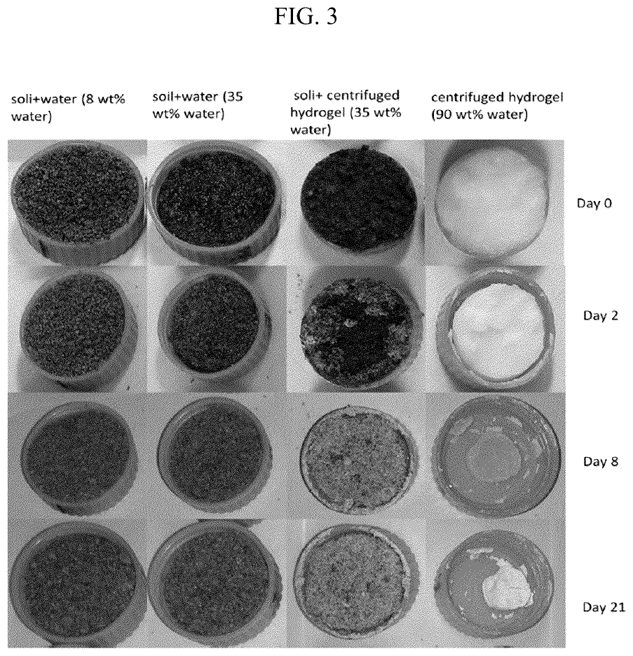

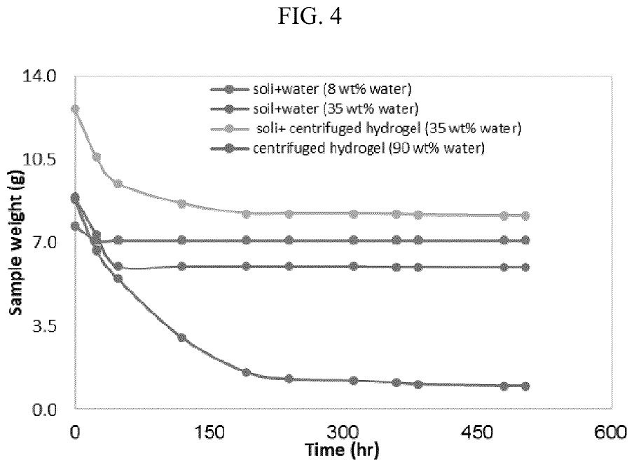

The aluminium hydroxide hydrogel will completely degrade and integrate into the compost soil when it dries. Aluminium ions are omnipresent in soils and will not introduce new or toxic elements into the soil. A separate experiment on the aluminium hydrogel demonstrated the degradation of the hydrogel to tiny fragments when it loses its water. Additionally, the pH and density of aluminium hydrogel, pH 7.1 and 1 g/mL, respectively, are similar to fresh water and will have a minimum impact on the soil environment (FIGS. 2A and 2B). Experimental work showed that aluminium hydrogel lost 50% of its weight after 13 days of exposure to the atmosphere at 25° C. FIG. 2C shows that water content in aluminium hydrogel decreased from 2.98 to 1.47 g after 13 days, demonstrating the ability of the hydrogel to retain water for a long time. Evaporation tests of different wet soils, centrifuged hydrogel-compost mixture, and centrifuged hydrogel samples were assessed at room temperature (22-25° C.). The results in FIGS. 3 and 4 show that the wet soil samples dried completely after a couple of days while 4000 rpm centrifuged aluminium hydroxide hydrogel dried completely after 21 days. Therefore, the aluminium hydroxide hydrogel keeps the water more than soil and increases the soil's water-holding capacity.

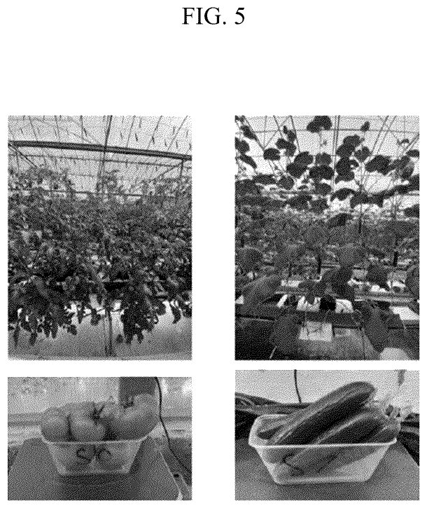

The aluminium hydroxide hydrogel has been tested in a real-life greenhouse to grow cucumbers and tomatoes. A 4 mm hydrogel layer was positioned in grow bags at two different locations: one time, the hydrogel layer was placed at the top just a few millimeters below the surface in another set the hydrogel was placed in the middle of the grow bags. In addition, three different irrigation schemes were applied. The first set of plantations was irrigated with water only (i.e. as used by the farm), the second set of plantations was irrigated with 66% water (i.e. 34% less water), and the third set of plantations was irrigated with only 33% water (i.e. 67% less water). FIG. 5 shows a fully grown tomatoes and cucumbers sample using the new hydrogel material.

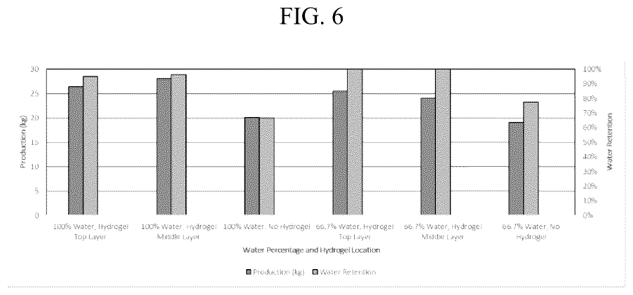

The growth rate, amount of production, and retained water were measured in the real-life greenhouse. FIG. 6 shows the production (Kg) and water retention (%) for the plantation of cucumber with the hydrogel placed in the soil top layer and the middle soil layer with 100% and 66.7% irrigation water. It can be seen from FIG. 6 that soils with hydrogel retained almost 100% of the irrigation water and the production with hydrogel agriculture was higher than in soils with no hydrogel applied. In the case of the 100% water with the hydrogel being placed in the topsoil layer, the production of cucumbers increased by almost 30% and by almost 24% with the hydrogel placed in the middle soil layer. In addition, it was noticed that the production of cucumbers with 66.7% irrigation water was higher than the production with 100% irrigation water which translates to almost 34% water saving and a 20% increase in production.

After plantation, the compost soil with the degraded aluminium hydrogel will be mixed with fresh compost for reuse in the new greenhouse plantation. This will reduce/eliminate the amount of waste generated from the agriculture industry and encourage organic food farming. Compost-aluminium hydrogel agriculture will reduce irrigation water and control nutrient movement in the soil, and eliminate chemicals/fertilizers in greenhouse agriculture.

The cost of making Aluminium hydroxide hydrogel is exceptionally low. For example, the cost of the chemicals to make 1 liter of this hydrogel is 0.3 USD for small scale experiments and 0.015 USD for large scale experiments. The capital and operating costs of making this hydrogel on a large scale are also very low. There is no need for expensive and complicated equipment, reactors, and process controls. Storage tanks and mixers are the main equipment needed to manufacture aluminium hydroxide hydrogel on large scales.

The present disclosure discloses a technology that uses cost-effective, degradable, and environmentally friendly aluminium hydroxide hydrogel for water supply to agriculture. An advantage of aluminium hydroxide is its compatibility with soils ingredients when degraded since aluminium is an essential element in all soils. Aluminium hydroxide hydrogel is a cost-effective hydrogel and can be easily prepared by one chemical reaction compared to other hydrogels and superabsorbents, which require a complicated preparation procedure. Further, the aluminium hydroxide hydrogel material is nontoxic and can be disposed of or mixed with the soil after use. It can be applied directly to the soil or compost for water storage and controlling nutrients transport in the soil. Green-house and farms can use the hydrogel directly to reduce water usage. Results showed that using hydrogel could enhance productivity and reduce the amount of irrigation water.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An aluminium hydroxide hydrogel, comprising:
aluminium polyhydrate and water.

2. The aluminium hydroxide hydrogel of claim 1, wherein the aluminium hydroxide hydrogel is used for agriculture.

3. The aluminium hydroxide hydrogel of claim 1, wherein a pH value of the aluminium hydroxide hydrogel is 7.1.

4. The aluminium hydroxide hydrogel of claim 1, wherein the aluminium hydroxide hydrogel is biodegradable.

5. A method for producing aluminium hydroxide hydrogel, comprising:
providing a mixture of aluminium hydroxide and water;
polymerizing aluminium hydroxide;
removing water from the aluminium hydroxide; and
washing the aluminium hydroxide.

6. The method of claim 5, wherein the water is removed from the aluminium hydroxide by a centrifuge.

7. The method of claim 5, wherein the aluminium hydroxide is washed to remove sodium ions and sulfate ions.

8. The method of claim 5, wherein the aluminium hydroxide hydrogel is used for agriculture.

9. The method of claim 5, wherein a pH value of the aluminium hydroxide hydrogel is 7.1.
